(19) United States
(12) Patent Application Publication
(10) Pub. No.: US 2005/0172599 A1
(43) Pub. Date: Aug. 11, 2005

(54) Collecting assembly for grass cutting

(76) Inventors: Jeffrey Q. Burcham, Mt. Airy, NC (US); Terry M. Burcham, Galax, VA (US)

Correspondence Address: Charles Y. Lackey, Post Office Box 5871, Winston-Salem, NC, 27113-5871, US

(21) Appl. No.: 10/753,284

(22) Filed: Jan. 9, 2004

(51) Int. Cl. A01D 43/00

(52) U.S. Cl. 56/202

(57) ABSTRACT

This invention is an apparatus for a lawn mower having a rotating blade enclosed by a deck. A grass catching hopper is removably secured to the mower. A first conduit communicates with a blower which induces increased airflow and moves grass clips and debris to the hopper interior. Controlled and enhanced air flow results from an air flow insert in the first conduit entrance. Air and entrained materials collide with a hopper interior wall, and a large amount of entrained materials drop to the hopper floor. Air and the small amount of entrained materials remaining in it are directed back toward the first wall and through an opening to a chamber containing a baffle system. Baffles within the baffle system sequentially engage air and entrained materials more of which fall to the floor of the baffle chamber. Air and what remains of the entrained materials are then drawn out of the chamber and back to the intake of the blower through a second conduit.

### BACKGROUND OF THE INVENTION

1. Field of the Invention

The present invention relates grass collection devices and, more particularly, to a collecting assembly for use in combination with a grass cutter or mower.

2. Description of the Prior Art

Previous lawn mowers have utilized a vacuum created by a rotating grass cutting blade to collect grass clippings and other debris within a grass catcher, thus obviating the need to rake. The rotating blade will act as an impeller to force air and solid debris into a grass catcher. Generally, the grass catcher has rearwardly positioned vents or mesh which retain solids such as grass clippings, twigs and leaves within the grass catcher but allows the flow of air in which the solids are entrained to pass through the grass catcher.

A problem associated with this type system is that dust particles are capable of filtering through the mesh, thus creating a dust cloud behind the mower which is unpleasant for the operator of the mower and which may be harmful to the mower's engine.

To alleviate this problem, a closed loop vacuum system was developed by Enters et al. in which air and associated dust entering the grass catcher is returned to the mower blade through another chute, and thereby recirculated, as opposed to being discharged into the atmosphere. However, the system disclosed by Enters et al. is complex and requires a multi-part grass catcher, including a rotating fan blade to increase the air flow generated by the mower blade from the solids sought to be deposited within the grass catcher.

Thus, a need exists for a closed loop lawn mower vacuum system which automatically separates solids entrained in the air flow passing through the grass catcher, without discharging the air flow to the atmosphere in a highly efficient manner. It is to this need that the present invention is directed.

### SUMMARY OF THE INVENTION

The present invention is a vacuum apparatus for a lawn mower that has a rotating blade and deck that encloses the blade. The vacuum apparatus includes a grass catcher or hopper that is removably secured to the mower. A first conduit communicates with a blower outside the deck which induces increased airflow and moves grass clips and debris to the hopper interior. Smooth, controlled and enhanced air flow is attained by an air flow insert positioned in the first conduit entrance at the deck so that air and entrained clips, debris and dust are guided up the insert and into and across the hopper interior and collide with the opposite hopper interior wall. A large amount of clips, debris and dust drops to the floor of the hopper and the air is directed back toward the first wall and through an opening forming the entry of a chamber containing a baffle system. Individual baffles within the baffle system sequentially engage the air and entrained materials removing at each engaged baffle small amounts of debris and dust which falls to the floor of the baffle chamber. The air and what remains of the debris and dust is then drawn out of the chamber and back to the intake of the blower through a second conduit. Thus nearly clean air flow goes to the blower intake and not to the blade enclosing deck for recirculation.

The hopper is movably mounted on the mower so that the mower operator can empty it when full without getting off the mower. Emptying the hopper cleans the hopper interior and the baffles. Alternatively, the mower can be equipped with plastic disposable bags mounted inside or outside the hopper if the terrain or circumstances make that use more acceptable.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention of the application, which is measured by its claims, nor to limit its scope in any way.

Thus, the objectives of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a side elevational perspective view of the present invention, a vacuum apparatus, installed on a riding mower;

FIG. 2 a rear elevational perspective view of the mower and vacuum apparatus shown in FIG. 1;

FIG. 3 is an other side elevational and perspective view of the mower and vacuum apparatus shown in FIGS. 1 and 2;

FIG. 4 is a perspective view of the first conduit showing the bottom of the conduit near its entrance being rolled clockwise so that the so that the conduit bottom becomes the conduit side at the entrance to the hopper;

FIG. 5 is a perspective, sectional and schematic view of the first conduit with a conduit insert extending inside the first conduit and around the first bend to improve, control and enhance air flow up the first conduit and into the hopper;

FIG. 6 is a schematic flow diagram showing the airflow and entrained clips, debris and dust moving through the chamber and baffle system within the hopper interior and out to a second conduit connected with the intake of the blower;

FIG. 7 is an end elevational and schematic view of air flow through the hopper first wall into the hopper interior against the hopper second or opposite wall, then back to the first hopper wall and through the entry port of the chamber containing the baffle system;

FIG. 8 is a schematic and side elevational view of the hopper inlets and outlets and the configuration of the baffle system;

FIG. 9 is a side elevational and perspective view of a utility dump box mounted on the riding mower; and

FIG. 10 is a side elevational and perspective view of the mower used with the collector apparatus which has been modified to convert the collection blower to a wide area blower.

### DETAILED DESCRIPTION OF THE PREFERRED EMBODIMENT

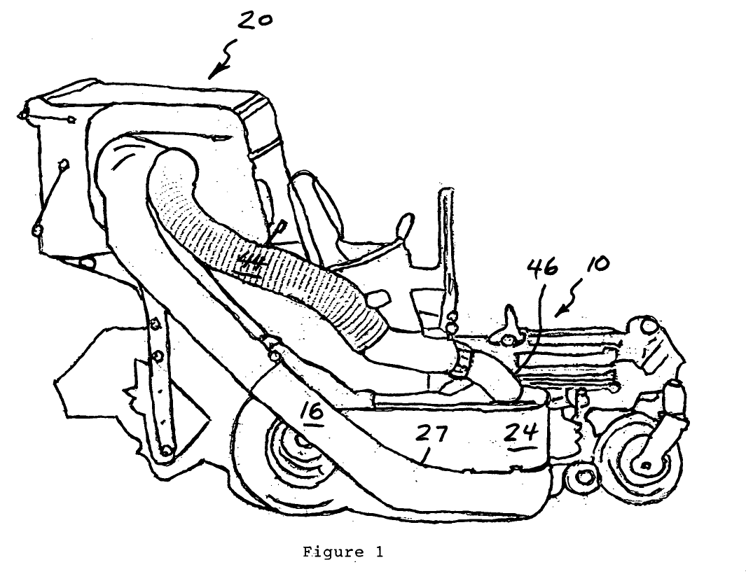

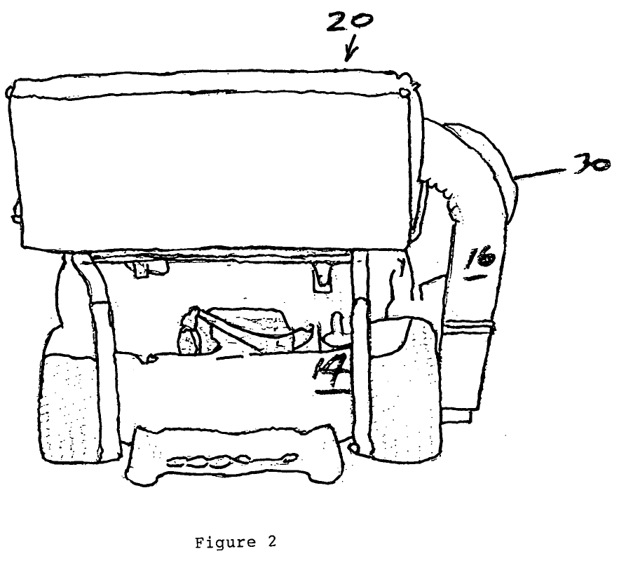

Referring now to the drawings and particularly to FIG. 1, a grass cutting machine such as a riding mower shown generally as 10 is equipped with a rotary cutting blade 12 positioned beneath mower 10 in a deck or housing 14 surrounding blade 12. A first conduit 16 extends from housing 14, into the chamber of a blower 24 and on to an opening 18 in a hopper 20. Because of the rotary movement of blade 12, air currents are set up which cause entrainment of the produced grass clipping, debris and dust in the turbulent body of air created by the movement of blade 12. Air flow from a blower 24, which can be located anywhere along conduit 16, induces greater air flow within conduit 16 which includes the moving clippings, debris and the like through first conduit 16 and into hopper 20. Air flow is enhanced in conduit 16 by the use of a carefully designed conduit insert 25 placed inside first conduit 16 at its opening next to mower housing 14 and extending beyond the curved section 27 of first conduit 16. Insert 25 is shaped to guide air and entrained debris flow smoothly around and along the flat and sharp surfaces of first conduit 16 that would, without such an insert, be slowed and less efficient. Air and entrained debris flow into and across hopper interior and collide with opposite wall 26. A large amount of the clippings and debris moving with the air flow are dislodged when they engage wall 26 and fall to the floor 28 of hopper 20.

The strong air flow rebounds from opposite wall 26 still carrying some small amounts of debris and dust and continues back through the hopper interior and out through opening 30 which is the entry to a chamber 32 formed by hopper exterior wall 34 and a hopper interior wall 36. Chamber 32 is narrow, only an inch or so wide, and holds a baffle system arranged as shown in FIG. 8 and illustrated generally as 38. The return air and small amount of remaining debris and dust passing through opening 30 then pass through baffle system 38 as depicted in FIG. 8. As individual baffles 40 are engaged by the air flow and carried debris and dust, small amounts of the remaining debris and dust is dislodged from the air flow and falls to the floor of chamber 32. Movement of the air and entrained debris and dust continues through the entire baffle system 38 continuing to dislodge small amounts of debris and dust upon engagement of each baffle 40 until it reaches port 42 which is the entrance to a second conduit 44.

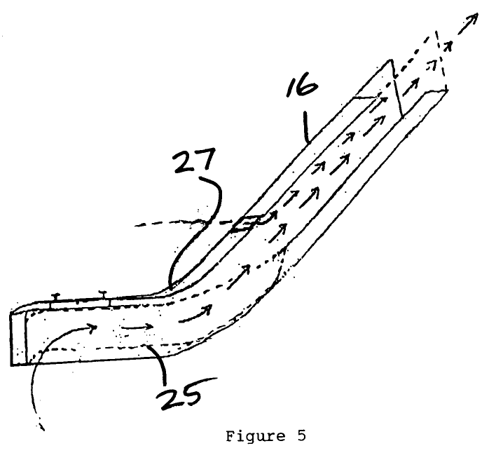

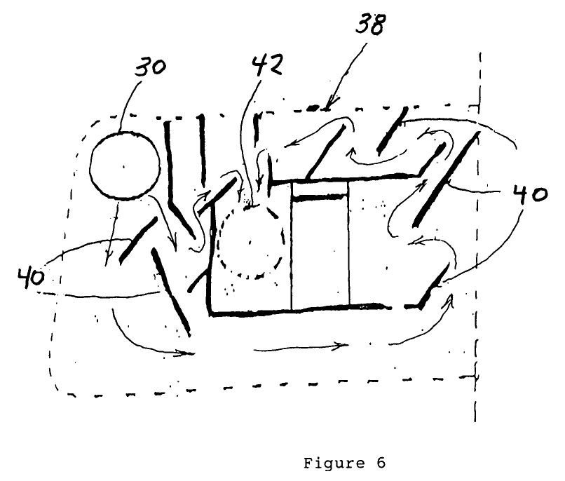

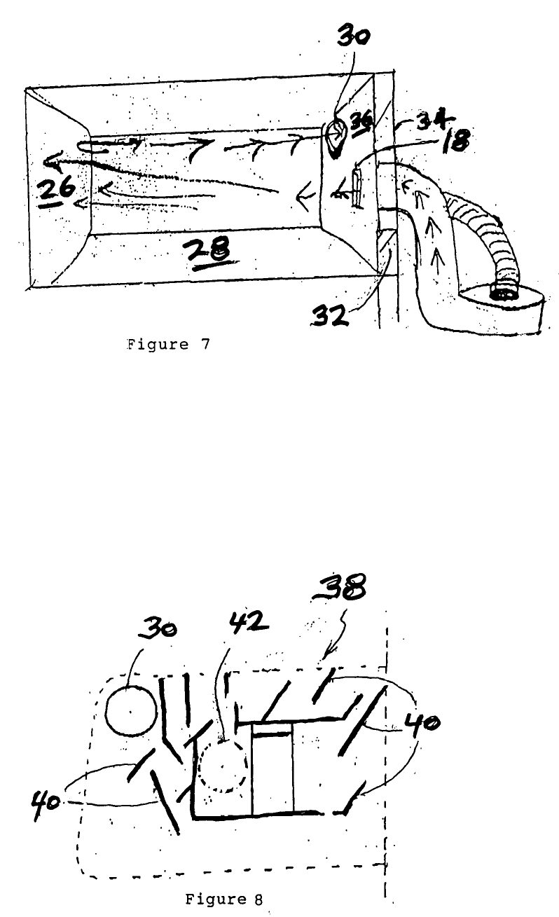

Conduit 44 extends to the intake 46 of blower 24 as shown in FIG. 5. The return air flow to intake 46 of blower 24 is relatively free from clippings, debris and dust since most of those materials were removed (fell to the bottom of chamber 32) when individual baffles 40 were encountered as the air flow and entrained materials moved completely through baffle system 38. The return air when entering the intake of blower 24 joins with the air flow pulling the newly formed clippings and debris out of the cutting area and into first conduit 16 to commence another cycle.

Several additional features of the present invention improve efficiency and operation and to overcome other troublesome features long associated with the riding mower industry. A small blower 24 has been used because it saves fuel and occupies a smaller space thus resulting in a smaller width of the entire system, adding only about 6 inches. It can be frame mounted or mounted on other machines if weight balancing is needed. It can also be provided with an on/off control which solves a long-standing requirement (problem) of having to remove the motor drive belt to disengage the blower.

Blower 24 can also be used with mower 10 to function as a wide area blower by disconnecting first conduit 16 and attaching a downwardly directed deflector 56 as shown in FIG. 10. First conduit 16 and hopper 20 have been removed in FIG. 10, however both components can be left in place while mower 10 and blower 24 operate to blow away surface debris by merely disconnecting blower 24 from first conduit 16. A guard grill 58 is installed over blower intake 46 to protect intake 46 from invasion by possibly damaging trash and debris.

Blower 24 can be disconnected or shut down and the grass cutting and collecting machine still operate in the manner described when blower 24 is running. The air flow created by rotary cutting blade 12 can in most cases be sufficient to move entrained clippings and debris through first conduit 16, through opening 18 of hopper 20 on to wall 26, back from wall 26 to and through chamber 32, out of hopper 20 through opening 30, then through second conduit 44 back to blower intake 46 and through blower intake 46 to first conduit 16. The amount of air flow can be varied when blower is off by adjusting the pitch of the blades of rotary cutting blade 12 to move more or smaller amounts of air.

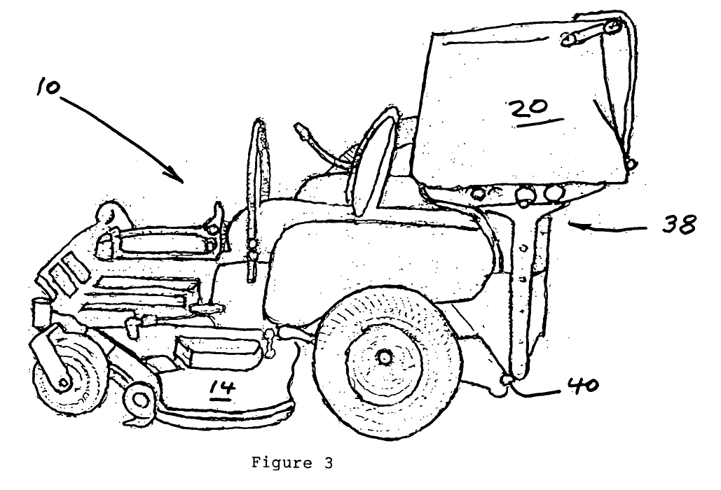

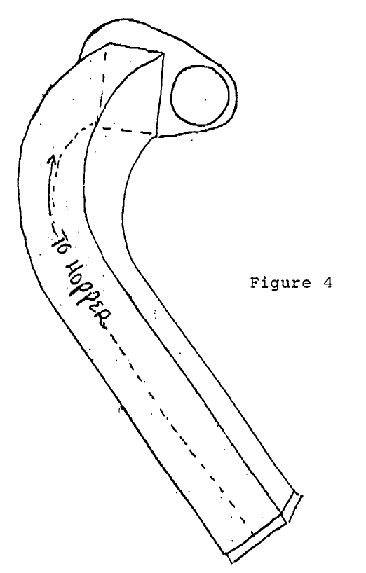

Hopper 20 is mounted (FIG. 3) to hold the length of the entire system to an increase of only 8 inches. It is preferably made of metal to minimize ridges and other irregular surfaces to reduce air flow resistance. Hopper 20 can be equipped with fabric bags carried inside or be bypassed in favor of fabric bags mounted elsewhere on the mower for clippings and debris collection.

Hopper 20 is mounted on a T-frame member shown generally as 50 which is pivotally connected to the rear lower end 52 of mower 10. T-frame member 50 can be tiltably controlled to dump hopper 20 rearwardly and near the ground so that dust and debris are kept away from the mower engine. The door 54 of hopper 20 opens progressively as hopper 20 is dumping, it moving to the top of hopper 20 for ground clearance. The location of hopper 20 puts weight forward of mower 10 and allows the use of little or no counterweights on zero turn mowers. The hopper dump handle is in a convenient location for easy access, movement and operation. It is unnecessary to leave the seat when operating it for any reason. Note that baffles 40 are cleared of debris and dust when hopper 20 iS emptied.

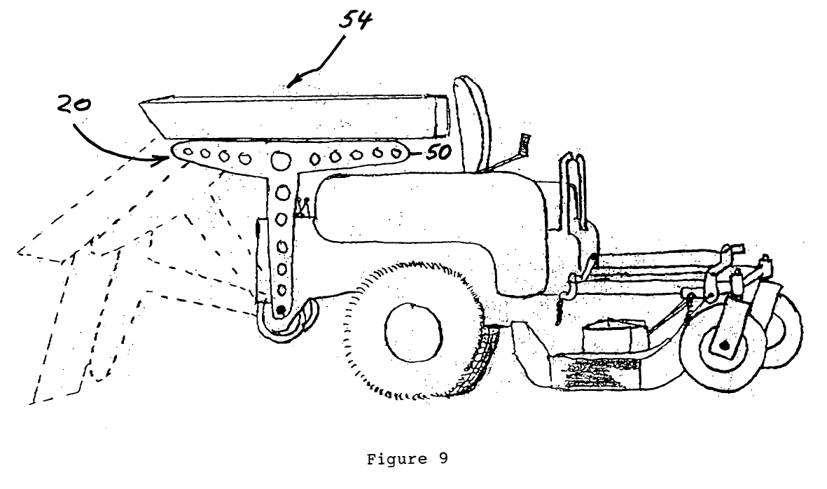

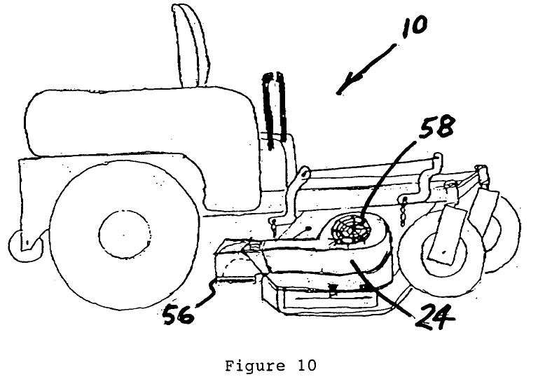

As an alternative to hopper 20, a dump bed body box generally shown as 54 (FIG. 9) is comprised of a box constructed of steel, aluminum or plastic and is mounted on T-frame member 50 like hopper 20. Varying sizes may be used as situations dictate.

The parts of the collecting assembly are simple to attach and detach using only factory bolt holes and pin mount locations on the mower. Lightweight materials and efficient fabrication methods keep the weight of the assembly at a minimum. Light weight metal chute and hopper construction outlasts plastic hoppers and hoses. All parts of the assembly fit into hopper 20 for storage.

It should be emphasized that the collector assembly of the present invention as generally described above can readily be mounted on any conventional type of riding mower, walk behind mower, push mower or the like. In addition, the specific disposition of the various components comprising the collector assembly relative to the cutting machine itself is not a limiting or important portion of the present invention as long as proper air flow is established from the cutting area, moves into and through first conduit 16, and then into and through hopper 20, through baffle system 38 and finally from baffle system 38 back to the intake of blower 24.

From the preceding description, it can be seen that a collecting assembly for use in combination with a cutting or mowing machine has been provided that will meet all of the advantages of prior art devices and offer additional advantages not heretofore available. With respect to the foregoing invention, the optimum relationship to the parts of the invention including variations in size, materials, shape, form, function and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

1. A grass collecting assembly for a lawn mower, the mower having a rotating blade, a deck enclosing the blade, and an outlet port in the deck, the collecting assembly comprising: a first conduit having a first end connecting with the deck outlet port and receiving air flow and entrained clips, debris and dust as the blade mows the grass; a blower communicating with the first conduit to induce greater air flow in the first conduit; a hopper having an exterior and an interior and an input opening formed therein receiving the first conduit second end for movement of air and entrained materials through the hopper interior until most of the entrained materials are dropped from the air flow that continues back toward the hopper input opening; a hopper interior wall forming a chamber within the hopper interior and having a opening to cooperatively receive the flowing air and the remaining entrained materials carried thereby; a baffle system positioned within the formed chamber and selectively located to intercept air flow and remove additional entrained materials; an output opening formed within the hopper exterior and interior wall of a second conduit, the conduit other end connecting with the intake of the blower.

2. A collecting assembly as claimed in claim 1 wherein the hopper has sides, two ends with interior walls and a door, one of the ends having an input opening formed therein receiving the first conduit second end for movement of air, clippings, debris and dust through the hopper and against the interior wall of the other hopper end where the majority of the entrained clippings, debris and dust collide with the other end interior wall and fall to the lowermost side while air flow and remaining entrained materials are reversed by collision with the other end interior wall and continue back toward the interior wall of the first end, the baffle system being made up of a plurality of flow intercepting individual baffles selectively positioned to intercept air flow, the output opening formed in the hopper first end and within the formed chamber and connecting with one end of a second conduit, the conduit other end connecting with the intake of the blower so that relatively clean air goes back into the first conduit to continue the collection operation.

3. A method of collecting grass clippings, debris and dust caused by mowing grass with a lawn mower comprising the steps of: collecting cut grass and associated entrained materials as mowing takes place; directing the cut grass and entrained materials along a predetermined path of travel; inducing increased air flow as the cut grass and entrained materials continue along the predetermined path of travel; directing the air flow and entrained materials into a collecting hopper; moving the air flow and entrained materials against a hopper interior wall so that the majority of the entrained materials collide with the interior wall and fall to the lowermost surface of the hopper and the air flow rebounds from the interior hopper surface and moves back toward the entrance of the hopper interior; subjecting the air flow and the remaining entrained materials to a baffle system having selectively positioned individual baffles to further reduce the quantity of entrained materials; and moving the air flow and remaining entrained materials out of the hopper and back to the location where increased induced air flow is occurring and thereby continue the collection operation.

4. The grass collecting assembly as claimed in claim 1 further comprising: a conduit insert positioned inside the first conduit designed to enhance and efficiently control air and debris flow within the first conduit.

5. The grass collecting assembly as claimed in claim 2 further comprising: a conduit insert positioned inside the first conduit designed to enhance and efficiently control air and entrained debris flow within the first conduit.
